(19) United States
(12) Patent Application Publication
(10) Pub. No.: US 2022/0405985 A1
(43) Pub. Date: Dec. 22, 2022

(54) AUGMENTED REALITY CONTENT GENERATION DEVICE AND AUGMENTED REALITY CONTENT DISPLAY DEVICE

(71) Applicant: HITACHI, LTD., Tokyo (JP)

(72) Inventors: Junichi KUWATA, Tokyo (JP); Shotaro TAMAYAMA, Tokyo (JP); Masaki TAKANO, Tokyo (JP)

(21) Appl. No.: 17/770,343

(22) PCT Filed: Jul. 31, 2020
(86) PCT No.: PCT/JP2020/029523

§ 371 Date: Apr. 20, 2022

(30) Foreign Application Priority Data
Mar. 23, 2020 (JP) 2020-050533

(51) Int. Cl. G06T 11/00; G06T 7/50

(52) U.S. Cl. CPC G06T 11/00; G06T 7/50

(57) ABSTRACT

An augmented reality content creation device includes: a determination part configured to, when a content virtually disposed in a real space is displayed in a display area having a transparent outer frame, determine whether or not the content has prescribed dimensions or larger with respect to the display area; and a highlighting part configured to, if the content is determined to have prescribed dimensions or larger with respect to the display area, highlight an edge of the content.

### CROSS REFERENCE TO RELATED APPLICATION

This application is a National Stage Application of PCT/JP2020/029523, filed on Jul. 31, 2020, and which application is incorporated herein by reference. To the extent appropriate, a claim of priority is made to the above disclosed application.

### TECHNICAL FIELD

The present invention relates to a technique of an augmented reality content generation device and an augmented reality content display device.

### BACKGROUND ART

In recent years, head-mounted displays which realize augmented reality have been used for on-site operations and HoloLens (registered trademark) developed by Microsoft Corporation has been applied to support the on-site operations. Usage of an augmented reality system in an on-site operation makes it possible to reference a large quantity of information, while a target object to be operated is visible. User's head movements alone allows information to be referenced, which is suited for such an on-site operation.

Patent Document 1 discloses an invention to provide an AR content individually depending on a business process to be performed.

### RELATED ART DOCUMENT

### Patent Document

Patent Document 1: Japanese Laid-Open Patent Application, Publication No. 2017-091561

### SUMMARY OF THE INVENTION

### Problem to be Solved by the Invention

The augmented reality system has, in some cases, difficulty recognizing whether or not a content is present also outside an area displayed by the system. There is a possibility that important information is overlooked or that information displayed is misinterpreted. Patent Document 1 fails to disclose visibility of a content.

In light of the described above, the present invention has been made in an attempt to enable to recognize whether or not a content is present also outside a display area.

### Means for Solving the Problem

An augmented reality content creation device includes: a determination part configured to, when a content virtually disposed in a real space is displayed in a display area having a transparent outer frame, determine whether or not the content has prescribed dimensions or larger with respect to the display area; and a highlighting part configured to, if the determination part determines that the content has prescribed dimensions or larger with respect to the display area, highlight an edge of the content.

An augmented reality content creation device includes: a determination part configured to, when a content virtually disposed in a real space is displayed in a display area having a transparent outer frame, determine whether or not the content is present also outside the display area; and a highlighting part configured to, if the determination part determines that the content is present also outside the display area, highlight an edge of the content.

An augmented reality content display device includes: a disposition part configured to virtually dispose a content in a real space; a display control part configured to display the content in a display area having a transparent outer frame; and a highlighting part configured to display the content with an edge thereof highlighted, if the content is determined to be present also outside the display area, and to display the content with an edge thereof not highlighted, if the content is determined to be accommodated in the display area.

Other means will be described in embodiment for carrying out the present invention.

### Advantageous Effect of the Invention

The present invention can recognize whether or not a content is present also outside a display area.

### BRIEF DESCRIPTION OF THE DRAWINGS

FIG. 1 is a diagram illustrating a configuration of an augmented reality system according to an embodiment of the present invention.

FIG. 2 is a diagram illustrating a field of view provided by the augmented reality system to a user according to the embodiment.

FIG. 3 is a block diagram illustrating a head-mounted display.

FIG. 4 is a diagram illustrating a structure of a content.

FIG. 5 is a diagram illustrating a field of view provided by an augmented reality system.

FIG. 6 is a diagram illustrating a field of view provided by an augmented reality system according to a comparative example.

FIG. 7 is a diagram illustrating a field of view provided by the augmented reality system according to the embodiment.

FIG. 8 is a diagram illustrating an example of a display in an augmented reality system according to a comparative example.

FIG. 9 is a diagram illustrating an example of a display in the augmented reality system according to the embodiment.

FIG. 10 is a diagram illustrating an example of a content with an edge thereof highlighted.

FIG. 11 is a diagram illustrating another example of a content with an edge thereof highlighted.

FIG. 12 is a diagram illustrating a still another example of a content with an edge thereof highlighted.

FIG. 13 is a diagram illustrating a content in an augmented reality system according to Variation 1.

FIG. 14 is a diagram illustrating a content in an augmented reality system according to Variation 2.

FIG. 15 is a diagram illustrating an example of a content with an edge thereof highlighted.

FIG. 16 is a diagram illustrating another example of a content with an edge thereof highlighted.

FIG. 17 is a diagram illustrating a still another example of a content with an edge thereof highlighted.

FIG. 18 is a flowchart illustrating an edge highlighting processing performed by a content creation device.

FIG. 19 is a flowchart illustrating a processing of an on-off switching of highlighting an edge, performed by the head-mounted display.

FIG. 20 is a flowchart illustrating an edge highlighting processing performed by the head-mounted display.

### EMBODIMENTS FOR CARRYING OUT THE INVENTION

Embodiments for carrying out the present invention are described below in detail with reference to the related drawings.

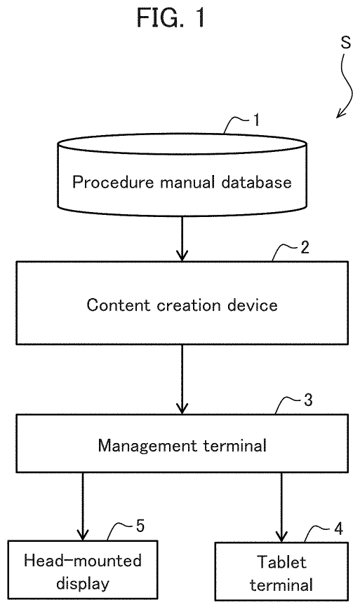

FIG. 1 is a diagram illustrating a configuration of an augmented reality system S according to an embodiment of the present invention.

The augmented reality system S includes a procedure manual database 1, a content creation device 2, a management terminal 3, a tablet terminal 4, and a head-mounted display 5. The augmented reality system S provides a user such as, for example, an on-site operator with augmented reality, to thereby assist an operation performed by the user.

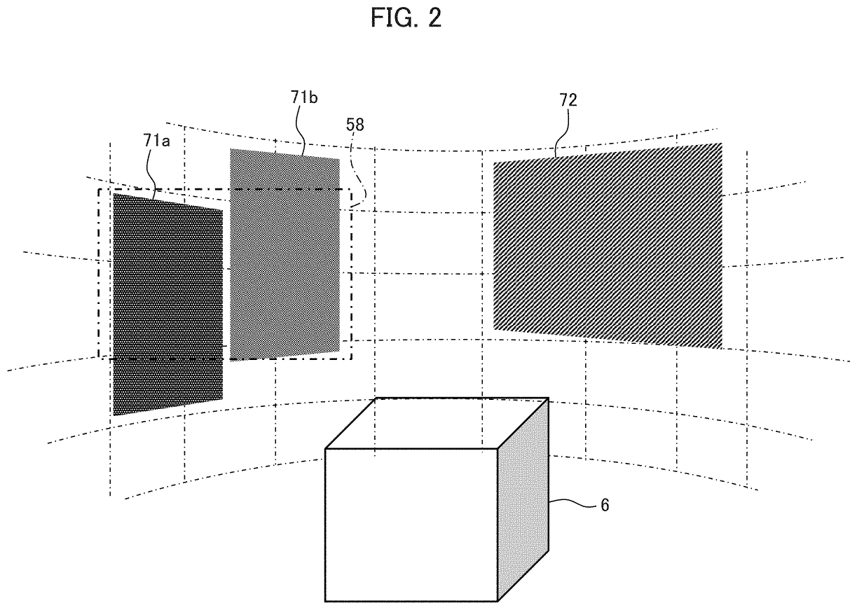

FIG. 2 is a diagram illustrating a field of view provided by the augmented reality system S to a user according to the embodiment.

A cylinder virtually placed in a real space has an inside in which: procedure manual contents 71a, 71b, each representing a procedure manual prepared for a user's advance request for reference during an operation; a figure content 72 representing a figure illustrating an internal structure of an operation target 6; or the like are virtually disposed.

When the head-mounted display 5 is turned in a different direction, the augmented reality system S: recognizes a direction of a display area 58 of the head-mounted display 5; and thereby updates a display state. When a user wears the head-mounted display 5 and turns a head thereof in some other direction, the user can see information within the display area 58 centered on a user's viewpoint. That is, the virtual cylinder is displayed as if disposed virtually in a real space.

When the user turns the head in another direction in which the display area 58 does not contain the procedure manual contents 71a, 71b or the figure content 72, the user can clearly see through the operation target 6 which is present behind those contents. That is, as the user moves the head thereof in a different direction, the user can switch his/her view between the operation target 6, the procedure manual contents 71a, 71b, and the figure content 72.

Referring back to FIG. 1, description is made. The procedure manual database 1 is a database that stores therein information such as a procedure manual and a figure to be provided to a user such as an on-site operator.

The content creation device 2: is a computer; and, when, for example, information on a procedure manual or a figure in the procedure manual database 1 is specified, creates a content corresponding thereto.

The management terminal 3 is a terminal for managing the content creation device 2. When a user operates the management terminal 3 to specify the procedure manual information or the figure information in the procedure manual database 1, the content creation device 2 creates a content corresponding thereto.

The tablet terminal 4 is a terminal for two-dimensionally previewing the created content.

The head-mounted display 5 is a content reproduction device for reproducing the content created by the content creation device 2.

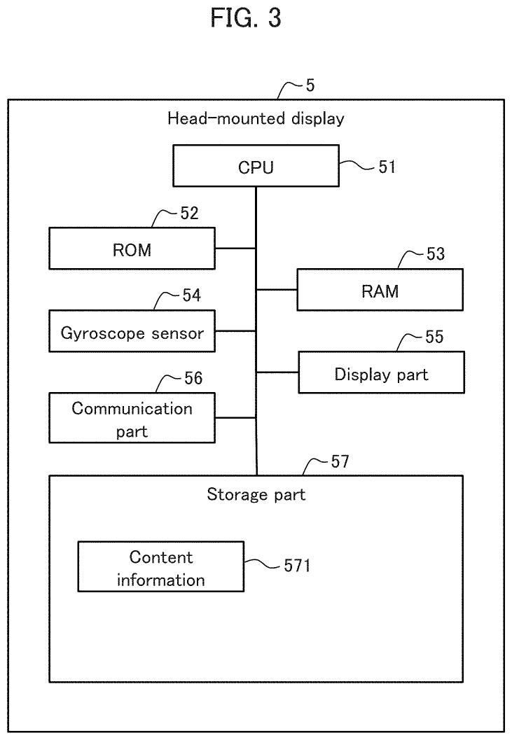

FIG. 3 is a block diagram illustrating the head-mounted display 5.

The head-mounted display 5: is a display device which is worn by a user on the head; and is called, for example, AR (Augmented Reality) glasses. The head-mounted display 5 is a computer including a CPU (Central Processing Unit) 51, a ROM (Read Only Memory) 52, a RAM (Random Access Memory) 53, and a storage part 57. The CPU 51 executes a program not illustrated and stored in the ROM 52 or the storage part 57, to thereby realize a function of reproducing a content.

The ROM 52: is a non-volatile memory; and stores therein, for example, a BIOS (Basic I/O System) or a program. The storage part 57: is a large-capacity storage device such as, for example, a flash memory; and stores therein content information 571, a program, or the like.

The head-mounted display 5 includes a gyroscope sensor 54, a display part 55, and a communication part 56.

The gyroscope sensor 54 is a sensor that detects an angular acceleration. The CPU 51 detects a change in an orientation of the head-mounted display 5 via the gyroscope sensor 54.

The display part 55 is a transparent display board with a rectangular display panel embedded in a center thereof. Note that the display panel has an opaque content area and a transparent area other than the opaque content area.

The communication part 56: is used for communication with the outside; and is, for example, a Wi-Fi module.

FIG. 4 is a diagram illustrating a structure of a content.

A visual field 59 is an area that a user can see. The display area 58: is an area that the display part 55 of the head-mounted display 5 can display; and has a transparent outer frame. Contents 73, 74, 75 are virtually disposed in a real space. When the user turns the head, the visual field 59 changes accordingly. Thus, a relative position between the display area 58 of the head-mounted display 5 and each of the contents 73, 74, 75 also changes.

The content 73 is rectangular. A lower right portion thereof is displayed in the display area 58. The other portion is outside the display area 58.

The content 74 is circular. A lower left portion thereof is displayed in the display area 58. The other portion is outside the display area 58.

The content 75 is triangular. An upper portion thereof is displayed in the display area 58. The other portion is outside the display area 58.

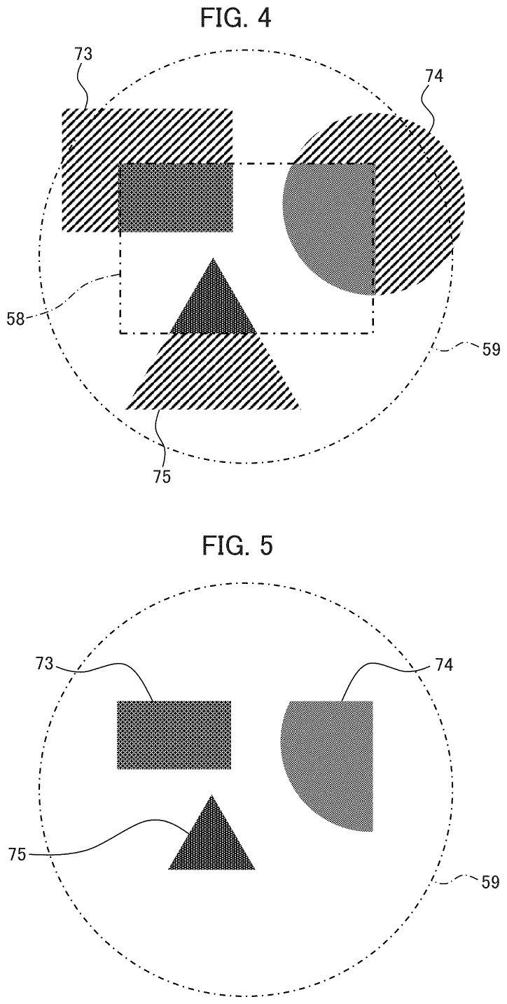

FIG. 5 is a diagram illustrating a field of view provided by the augmented reality system S.

The content 73 is rectangular. A portion thereof displayed in a display area 58 is also rectangular. A user cannot determine whether or not the entire content 73 is displayed in the display area 58.

The content 75 is triangular, and a portion thereof displayed in the display area 58 is also triangular. The user cannot determine whether or not the entire content 75 is displayed in the display area 58.

The content 74 is circular, and a portion thereof displayed in the display area 58 is a part of the circle. The user can determine that a part of the content 74 is displayed in the display area 58.

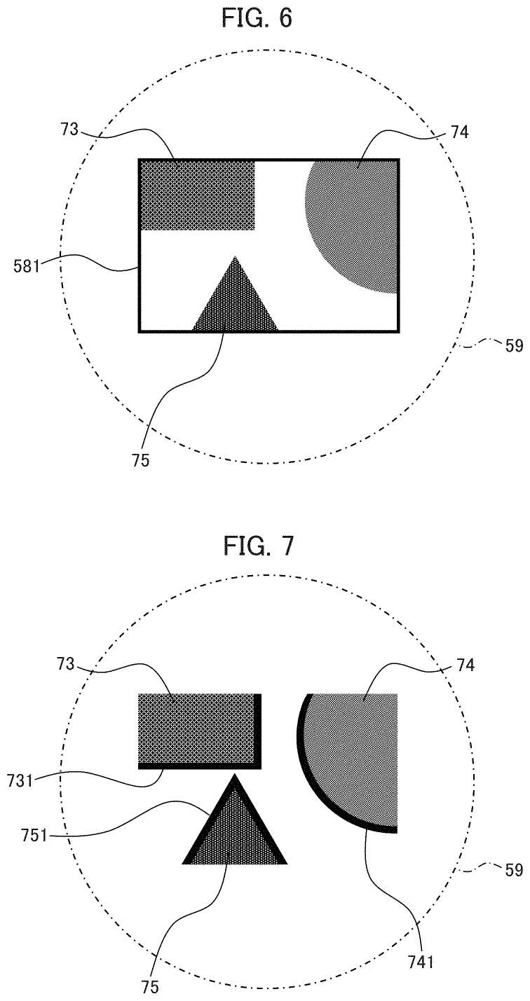

FIG. 6 is a diagram illustrating a field of view provided by an augmented reality system according to a comparative example.

In order to solve the problems described with reference to FIG. 5, an edge 581 of the display area 58 is highlighted. The comparative example has, however, a problem that the edge 581 inevitably obstructs a field of view of a user.

FIG. 7 is a diagram illustrating a field of view provided by the augmented reality system S according to this embodiment.

The augmented reality system S according to the embodiment highlights an edge 731 of the content 73. As illustrated, the augmented reality system S can separately display a case where a part of the content 73 is displayed in the display area 58 and another case where the entire content 73 is displayed therein, in distinction from each other.

The augmented reality system S highlights an edge 751 of the content 75. As illustrated, the augmented reality system S can separately display a case where a part of the content 75 is displayed in the display area 58 and another case where the entire content 75 is displayed therein, in distinction from each other.

The augmented reality system S highlights an edge 741 of the content 74. As illustrated, the augmented reality system S can separately display a case where a part of the content 74 is displayed in the display area 58 and another case where the entire content 74 is displayed therein, in distinction from each other. When the content 74 is circular, however, whether a part of or the entirety of the content 74 is displayed in the display area 58 can be distinguished not only by the edge 741 but also by a shape thereof.

In this embodiment, a user can make an unnecessary content undisplayed, just by turning the head thereof, which secures an appropriate field of view without being obstructed by the unnecessary content.

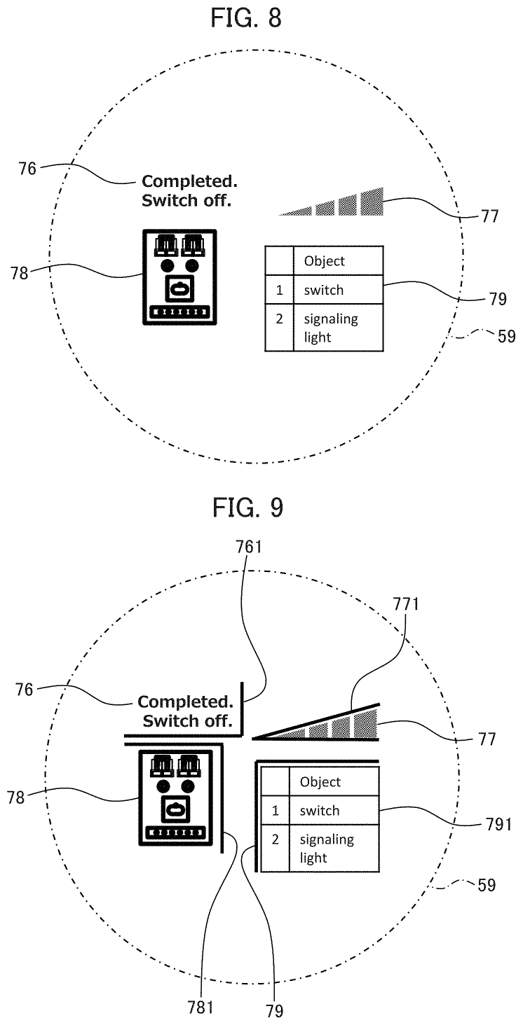

FIG. 8 is a diagram illustrating an example of a display in an augmented reality system according to another comparative example.

A content 76 contains a sentence; a content 77, a triangular indicator; a content 78, a figure; and, a content 79, a table.

It is difficult in some cases to determine whether or not each of the entire contents 76 to 79 is displayed.

FIG. 9 is a diagram illustrating a display example in the augmented reality system S according to the embodiment.

The content 76 is highlighted with an edge 761. This makes it possible for a user to determine that only a part of the sentence is displayed in a display area 59. Note that a content containing a sentence may also be herein referred to as a content of a group of characters.

The content 77 is highlighted with an edge 771. This makes it possible for the user to determine that a maximum value of the indicator is hidden to the right.

The content 78 is highlighted with an edge 781. This makes it possible for the user to determine that an undisplayed portion of the content 78 is present to the bottom left.

The content 79 is highlighted with an edge 791. This makes it possible for the user to determine that the content 79 still has one or more columns to the right and one or more rows to the bottom.

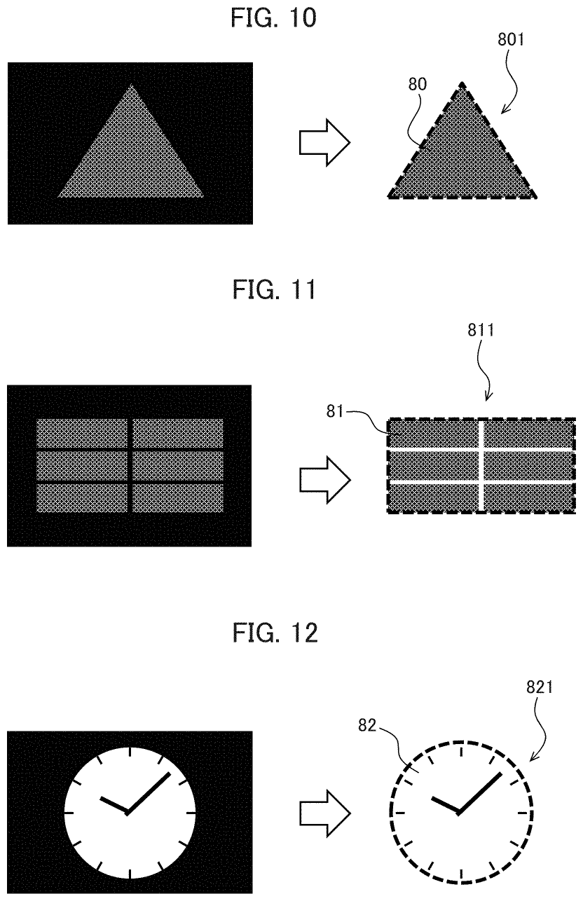

FIG. 10 is a diagram illustrating an example of a content with an edge thereof highlighted.

A content 80 is a single triangle. An edge 801 thereof corresponds to each of sides of the triangle.

FIG. 11 is a diagram illustrating another example of a content with an edge thereof highlighted.

A content 81 is a combination of a plurality of rectangles. An edge 811 thereof is shaped as a rectangle obtained by simplifying a general shape of the content 81.

FIG. 12 is a diagram illustrating a still another example of a content with an edge thereof highlighted.

A content 82 is a clock. An edge 821 thereof is shaped as a circle obtained by simplifying a general shape of the content 82.

### <<Relationship Between Shape of Display Area and Shape of Content>>

A display area is typically rectangular. When a shape of a content is also rectangular and a part of the content is displayed in the display area, the displayed part also becomes rectangular. It is thus difficult to determine whether or not the content is present also outside the display area.

When the display area is hexagonal or pentagonal, a similar problem occurs. Next is described the problem.

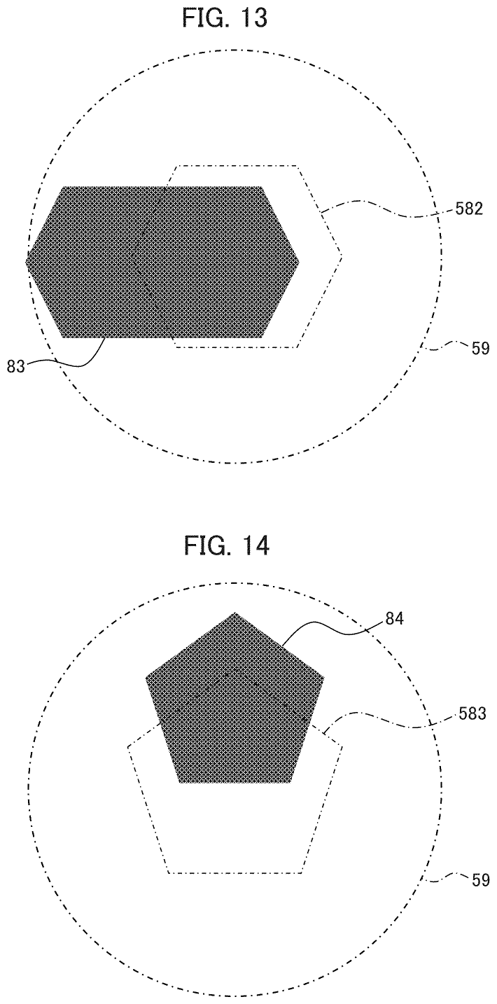

FIG. 13 is a diagram illustrating a content in an augmented reality system according to Variation 1.

A display area 582 is herein hexagonal and a content 83 is also hexagonal. A part of the content 83 displayed in the display area 582 also becomes hexagonal. It is thus difficult for a user to determine whether or not the content 83 is present also outside the display area 582.

When the display area 582 is hexagonal, the content creation device 2 according to the embodiment may thus highlight the hexagonal content 83 with an edge.

FIG. 14 is a diagram illustrating a content in an augmented reality system according to Variation 2.

A display area 583 is herein pentagonal and a content 84 is also hexagonal. A part of the content 84 displayed in the display area 583 also becomes pentagonal. It is thus difficult for a user to determine whether or not the content 84 is present also outside the display area 582.

When the display area 583 is pentagonal, the content creation device 2 according to the embodiment may thus highlight the pentagonal content 84 with an edge.

### <<Edge of Content>>

An edge of an content is preferably designed to fade out from a portion nearer to an inside of the content toward a portion father thereto. This makes it possible for a user not to confuse the inside of the content with the outside thereof.

It is preferable that an edge of a content does not have a linear end face or a simple gradation but has a shape which is not used in the content and also does not penetrate into the inside of the content. This makes it possible for a user not to confuse the inside of the content with the outside thereof. The edge may be made up of specific patterns repeatedly arranged along a contour of the content. This allows the content creation device 2 to mechanically create an edge and a user to easily distinguish the edge from the other part.

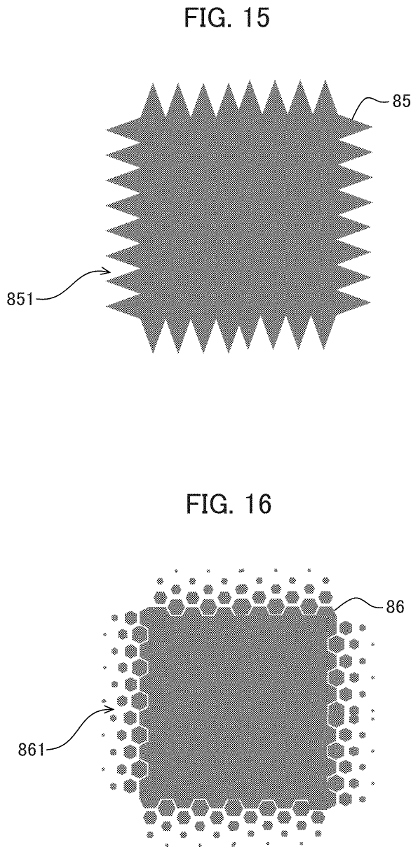

FIG. 15 is a diagram illustrating an example of a content with an edge thereof highlighted.

An edge 851 of a content 85 is made up of wedges, each extending from the inside to the outside thereof. The shape of the edge 851 is preferable because a user can easily distinguish the inside of the content from the outside thereof.

FIG. 16 is a diagram illustrating another example of a content with an edge thereof highlighted.

An edge 861 of a content 86 is made up of hexagons which become less dense with an increasing distance from the inside of the content 86 toward the outside thereof. The shape of the edge 861 is preferable because a user can easily distinguish the inside of the content from the outside thereof.

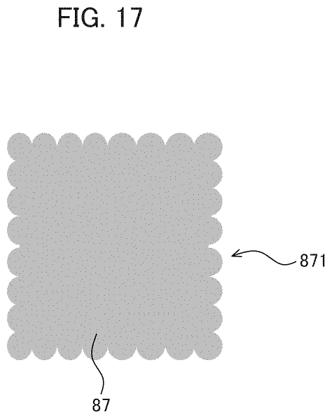

FIG. 17 is a diagram illustrating a still another example of a content with an edge thereof highlighted.

An edge 871 of a content 87 is made up of semicircles each protruding from the inside toward the outside thereof. The shape of the edge 871 is preferable because a user can easily distinguish the inside of the content from the outside thereof.

### <<Edge Highlighting Processing by Content Creation Device>>

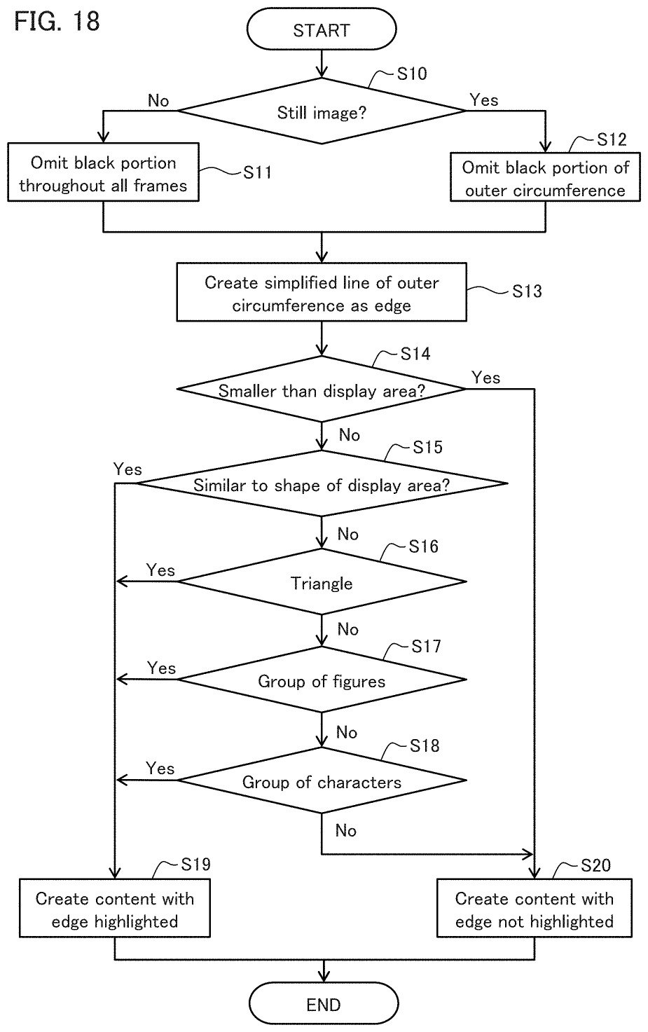

FIG. 18 is a flowchart illustrating an edge highlighting processing performed by the content creation device 2.

When the processing starts, a processing part not illustrated (for example, a CPU) of the content creation device 2 determines whether or not a content to be created is a still image (S10). If the content is determined to be a still image (Yes), the processing part: omits a black portion of an outer circumference of a content (S12); and advances the processing to step S13. If the content is determined to be a moving image (No), the processing part: omits a portion which is black throughout all frames (S11); and advances the processing to step S13.

In step S13, the processing part creates an appropriately simplified line of the outer circumference from which the portion omitted in steps S11 or S12 is deleted.

Steps S14 to S18 corresponds to a processing of determining whether or not an edge of the content is to be highlighted.

In step S14, the processing part determines whether or not the content is smaller than a size of an area in which the content is to be displayed. In step S14, the processing part serves as a determination part that determines whether or not the content has prescribed dimensions or larger with respect to a display area. Note that “a content is small” herein means that, for example, a height and a width of a content displayed in a display area is a 25% or smaller than a height and a width of the display area.

If the content is determined to be smaller than the size of the display area (Yes), the processing part: advances the processing to step S20; creates a content with an edge thereof not highlighted; and terminates the processing of FIG. 18. If the content is not determined to be smaller than the size of the display area (No), the processing part advances the processing to step S15.

In step S15, the processing part determines whether or not the content has a shape similar to that of the display area. If the content is determined to have the shape similar to that of the display area (Yes), the processing part: advances the processing to step S19; creates a content with an edge thereof highlighted; and terminates the processing of FIG. 18. In step S19, the processing part serves as a highlighting part that highlights an edge of a content.

In step S15, if the content is not determined to have the shape similar to that of the display area (No), the processing part advances the processing to step S16.

In step S16, the processing part determines whether or not the content is triangular. If the content is determined to be triangular (Yes), the processing part: advances the processing to step S19; creates a content with an edge thereof highlighted; and terminates the processing of FIG. 18. If the content is not determined to be triangular (No), the processing part advances the processing to step S17.

In step S17, the processing part determines whether or not the content is composed of a group of figures. If the content is determined to be composed of the group of figures (Yes), the processing part: advances the processing to step S19; creates a content that has a shape of a rectangle slightly larger than a rectangle which can accommodate the entire group of figures, and also has a highlighted edge; and terminates the processing of FIG. 18.

If the content is not determined to be composed of a group of figures (No), the processing part advances the processing to step S18.

In step S18, the processing part determines whether or not the content is composed of a group of characters. If the content is determined to be composed of the group of characters (Yes), the processing part: advances the processing to step S19; creates a content that has a shape of a rectangle slightly larger than a rectangle which can accommodate the entire group of characters, and also has a highlighted edge; and terminates the processing of FIG. 18. If the content is not determined to be composed of a group of characters (No), the processing part: advances the processing to step S20; creates a content with an edge thereof not highlighted; and terminates the processing of FIG. 18.

That is, in steps S17 and S18, the processing part serves as a group determination part that determines whether or not the content is composed of a group of figures and whether or not the content is composed of a group of characters, respectively.

The processing part may adjust a tone of an edge of a content in accordance with a color of the content. When, for example, a content is in simple color, an edge thereof may be highlighted with a tone same as that of the content. When a content is multicolored, an edge thereof may be highlighted in a color in accordance with brightness of the whole content. This makes it possible to prevent the highlighting by the processing part from being too bright or too dark.

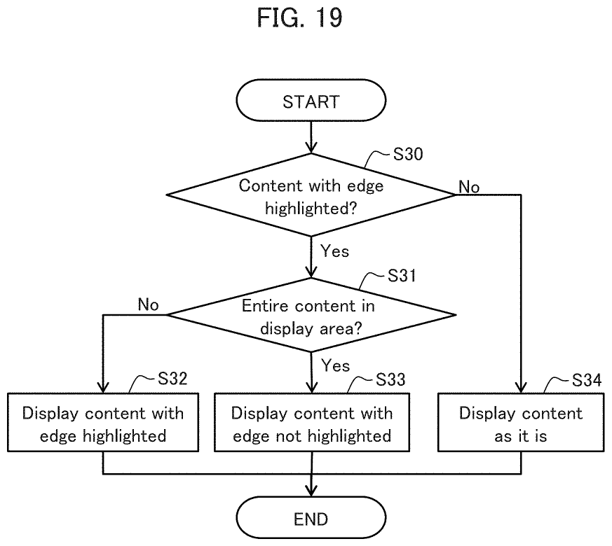

FIG. 19 is a flowchart illustrating a processing of an on-off switching of highlighting an edge, performed by the head-mounted display 5. The switching processing is called, for example, each time a display processing of a frame is conducted. The switching processing is performed on the presumption that whether or not an edge of a content of interest is to be highlighted has already been determined in FIG. 18 and that, when the content is determined to be created with the edge thereof highlighted, both a content with the edge thereof highlighted and another with the edge thereof not highlighted are created.

The CPU 51 determines whether or not a content with an edge thereof highlighted is present in one or more contents (S30). If a content with an edge thereof highlighted is not determined to be present therein (No), the CPU 51: advances the processing to step S34; displays the one or more contents as they are; and terminates the processing of FIG. 19. If a content with an edge thereof highlighted determined to be present therein (Yes), the CPU 51 advances the processing to step S31.

In step S31, the CPU 51 determines whether or not the entire content is accommodated in a display area. The determination processing is performed to each of the one or more contents. If the entire content is determined to be accommodated in the display area (Yes), the CPU 51 displays a content corresponding thereto with an edge thereof not highlighted (S33); and terminates the processing of FIG. 19.

If the entire content is not determined to be accommodated in the display area (No), the CPU 51 displays a corresponding thereto content with the edge thereof highlighted (S32); and terminates the processing of FIG. 19.

### <<Edge Highlighting Processing by Head-Mounted Display>>

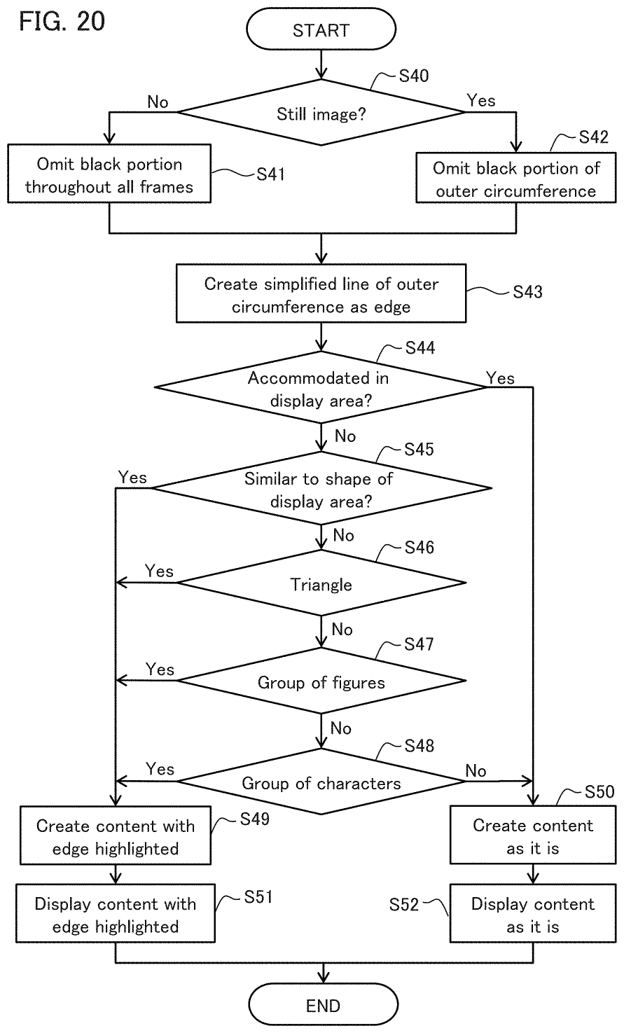

FIG. 20 is a flowchart illustrating an edge highlighting processing performed by the head-mounted display 5. The processing is a variation of the embodiment described with reference to FIG. 18.

Steps S40 to S43 are the same as steps S10 to S13 in FIG. 18.

In step S44, the processing part determines whether or not an entire content is accommodated in a display area. If the entire content is determined to be accommodated in the display area (Yes), the processing part advances the processing to step S50. If the content is not determined to be accommodated in the display area (No), the processing part advances the processing to step S45. Steps S45 to S50 are the same as step S15 to S20 in FIG. 18.

In step S51, the CPU 51: displays a corresponding content with an edge thereof highlighted; and terminates the processing of FIG. 20. In step S52, the CPU 51: displays a content as it is; and terminates the processing of FIG. 20. In steps S51 and S52, the CPU 51 serves as a display control part that makes a content displayed in a display area having a transparent outer frame.

### <<Other Variations>>

The present invention is carried out not only by the above-described embodiment but also by variations of many types. For example, the above-described embodiment is intended to be illustrative of the present invention in an easily understandable manner and the present invention is not limited to the one including all of the components explained in the embodiment. Part of a configuration of an example of the present invention may be substituted by or added to that of another example. Part of a configuration of an example may be deleted.

A part or all of configurations, features, processing parts, processing units, or the like can be realized by hardware by means of, for example, designing of integrated circuits. The above-described configurations, features, or the like can be embodied by software in which, for example, a processor interprets and executes a program which realizes the features or the like. Data in a program, a table, a file, and the like for realizing such a feature can be stored in a storage device including a memory, a hard disk, and a SSD (Solid State Drive) or in a storage medium including a flash memory card and a DVD (Digital Versatile Disk).

In the present invention, only a control line or an information line which is deemed necessary for explanation is illustrated, and not all of them which are necessary for a product are illustrated. In practice, almost all elements are deemed to be connected to each other.

Other variations of the present invention are, for example, (a) to (e) as follows.

(a) A shape of a content in an augmented reality is not limited to a simple figure such as a polygon and a circle but may be, for example, a complex figure such as a heavy machinery and a plant device.
(b) An edge of a content may be designed not to fade out from a portion nearer to an inside of the content toward a portion father thereto.
(c) An edge of a content may have a shape same as that used in the content.
(d) An edge of a content may have a shape which penetrates into the inside of the content.
(e) Functions of creating and displaying a content may be implemented not only in a system including a plurality of devices but also in the head-mounted display 5.

### DESCRIPTION OF REFERENCE NUMERALS

S augmented reality system
1 procedure manual database
2 content creation device
3 management terminal
4 tablet terminal
5 head-mounted display
51 CPU
52 ROM
53 RAM
54 gyroscope sensor
55 display part
56 communication part
57 storage part
571 content information
58, 582, 583 display area
581 edge
59 visual field
6 operation target
71a, 71b procedure manual content
72 figure content
73-87 content
731-821, 851-871 edge

1. An augmented reality content creation device, comprising:
a determination part configured to, when a content virtually disposed in a real space is displayed in a display area having a transparent outer frame, determine whether or not the content has prescribed dimensions or larger with respect to the display area; and
a highlighting part configured to, if the determination part determines that the content has prescribed dimensions or larger with respect to the display area, highlight an edge of the content.

2. An augmented reality content creation device, comprising:
a determination part configured to, when a content virtually disposed in a real space is displayed in a display area having a transparent outer frame, determine whether or not the content is present also outside the display area; and
a highlighting part configured to, if the determination part determines that the content is present also outside the display area, highlight an edge of the content.

3. The augmented reality content creation device according to claim 1,
further comprising a shape determination part configured to determine a shape of the content,
wherein the highlighting part is configured to switch whether or not the edge of the content is highlighted in accordance with the shape or a type of the content determined by the shape determination part.

4. The augmented reality content creation device according to claim 1, wherein the determination part is configured to determine whether or not a shape of the display area is similar to a shape of the content, and
wherein the highlighting part is configured to, if the shape of the display area is similar to the shape of the content, highlight the edge of the content.

5. The augmented reality content creation device according to claim 3,
wherein the highlighting part is configured to, if the shape of the content is triangular, highlight the edge of the content.

6. The augmented reality content creation device according to claim 1, further comprising a group determination part configured to determine whether or not the content is composed of a group of figures or a group of characters,
wherein the highlighting part is configured to, if the content is composed of the group of figures or the group of characters, highlight the edge of the content.

7. The augmented reality content creation device according to claim 1, wherein the highlighting part is configured to create the edge of the content by simplifying an outer circumference of the content.

8. An augmented reality content display device, comprising:
a disposition part configured to virtually dispose a content in a real space;
a display control part configured to display the content in a display area having a transparent outer frame; and
a highlighting part configured to display the content with an edge thereof highlighted, if the content is determined to be present also outside the display area, and to display the content with an edge thereof not highlighted, if the content is determined to be accommodated in the display area.

9. The augmented reality content creation device according to claim 2,
further comprising a shape determination part configured to determine a shape of the content,
wherein the highlighting part is configured to switch whether or not the edge of the content is highlighted in accordance with the shape or a type of the content determined by the shape determination part.

10. The augmented reality content creation device according to claim 2,
wherein the determination part is configured to determine whether or not a shape of the display area is similar to a shape of the content, and
wherein the highlighting part is configured to, if the shape of the display area is similar to the shape of the content, highlight the edge of the content.

11. The augmented reality content creation device according to claim 2,
further comprising a group determination part configured to determine whether or not the content is composed of a group of figures or a group of characters,
wherein the highlighting part is configured to, if the content is composed of the group of figures or the group of characters, highlight the edge of the content.

12. The augmented reality content creation device according to claim 2,
wherein the highlighting part is configured to create the edge of the content by simplifying an outer circumference of the content
